(19) United States
(12) Patent Application Publication
(10) Pub. No.: US 2020/0097707 A1
(43) Pub. Date: Mar. 26, 2020

(54) Camera Module and Extended Reality System Using the Same

(71) Applicant: XRSpace CO., LTD., Taoyuan City (TW)

(72) Inventors: Peter Chou, Taipei City (TW); Chun-Wei Lin, Taoyuan City (TW); Yi-Kang Hsieh, Hsinchu County (TW); Chia-Wei Wu, New Taipei City (TW); Chuan-Chang Wang, Taipei City (TW)

(21) Appl. No.: 16/136,257

(22) Filed: Sep. 20, 2018

(51) Int. Cl. G06K 9/00; H04N 13/282; H04N 5/232; H04N 9/07; H04N 13/275; G06F 3/01

(52) U.S. Cl. CPC G06K 9/00355; H04N 13/282; H04N 5/23299; H04N 9/07; H04N 2013/0077; H04N 5/23219; H04N 13/275; G06F 3/012; H04N 5/23238

(57) ABSTRACT

A camera module, for a head-mounted display (HMD), includes a first optical module for tracking a hand motion of a user; a second optical module for reconstructing a hand gesture or a step of the user and a space; a third optical module for establishing a three-dimensional (3D) virtual object; and a control unit for integrating with the first optical module, the second optical module and the third optical module to virtualize a body behavior of the user; wherein the camera module is rotatable to maximize a tracking range.

### BACKGROUND OF THE INVENTION

### 1. Field of the Invention

The present invention relates to a camera module and an extended reality system, and more particularly, to a camera module and an extended reality system capable of virtualizing body behavior of a user.

### 2. Description of the Prior Art

With the advancement and development of technology, the demand of interactions between a computer game and a user is increased. Human-computer interaction technology, e.g. somatosensory games, virtual reality (VR) environment, augmented environment (AR) and extended reality (XR) environment, becomes popular because of its physiological and entertaining function. The conventional XR technology reconstructs virtual objects and virtualizes the user by tracking movements of the user with an outside-in tracking method, which traces a scene coordinates of moving objects in real-time, such as head-mounted displays (HMDs), motion controller peripherals or cameras. In this way, the HMDs, the motion controller peripherals or cameras may work together to react to gestures made by the user while in the virtual environment, so as to simultaneously provide interactions to the user in the virtual environment.

However, when the conventional XR technology works without the motion controller peripherals or cameras to track the motions or gestures of the user, the HMD cannot virtualize the gestures or movements of the user and affects the user experience.

### SUMMARY OF THE INVENTION

Therefore, the present invention provides a camera module and an extended reality system to provide a better usage scenario to the user.

The present invention discloses a camera module, for a head-mounted display (HMD), comprising a first optical module for tracking a hand motion of a user; a second optical module for reconstructing a hand gesture or a step of the user and a space; a third optical module for establishing a three-dimensional (3D) virtual object; and a control unit for integrating with the first optical module, the second optical module and the third optical module to virtualize a body behavior of the user; wherein the camera module is rotatable to maximize a tracking range.

The present invention further discloses an extended reality system, comprising a head-mounted display; and a camera module disposed on the head-mounted display, and the camera module comprises a first optical module for tracking a hand motion of an user; a second optical module for reconstructing a hand gesture of the user and a space; a third optical module for establishing a three-dimensional (3D) virtual object; and a control unit for integrating with the first optical module, the second optical module and the third optical module to virtualize a body behavior of the user; wherein the camera module is rotatable on the HMD to maximize a tracking range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an extended reality system according to an embodiment of the present invention.

FIG. 2 is a schematic diagram of a camera module according to an embodiment of the present invention.

FIGS. 3A and 3B are schematic diagrams of the extended reality system when applied on a user according to an embodiment of the present invention.

### DETAILED DESCRIPTION

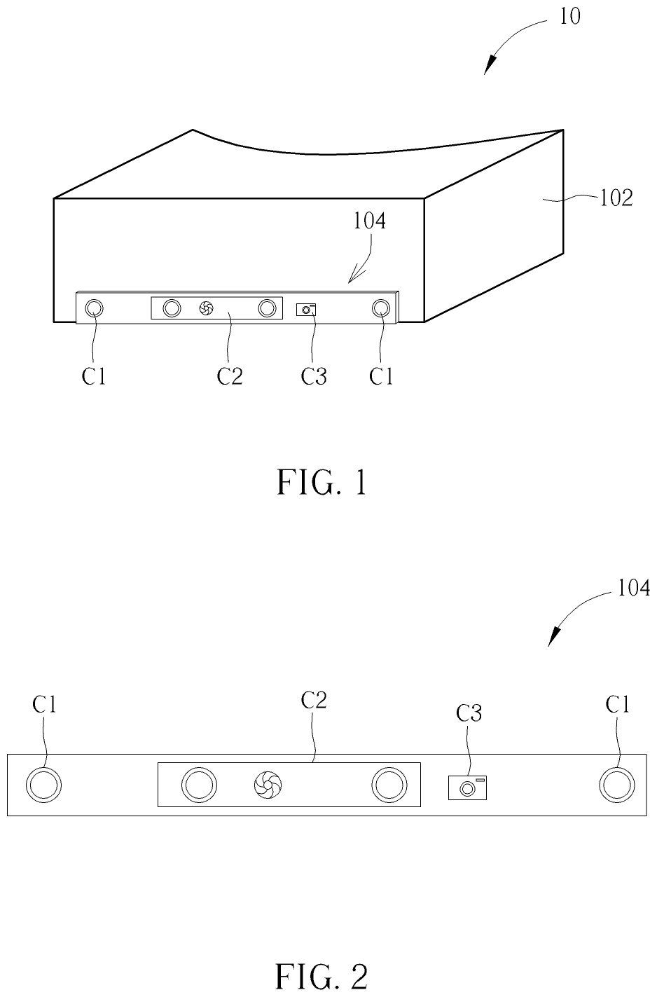

Please refer to FIG. 1, which is a schematic diagram of an extended reality system 10 according to an embodiment of the present invention. The extended reality system 10 includes a head-mounted display (HMD) 102 and a camera module 104. The HMD 102 may be worn by a user and configured to present various graphics, such as a view of a virtual space with a plurality of virtual objects, in a display portion of the HMD 102. The camera module 104, as shown in FIG. 2, may be disposed or mounted on the HMD 102, which includes a first optical module C1 for tracking a hand motion of the user, a second optical module C2 for reconstructing a space and a hand gesture or a step of the user, a third optical module C3 for establishing a three-dimensional (3D) virtual object, and a control unit 106 for integrating with the first optical module C1, the second optical module C2 and the third optical module C3 to virtualize a body behavior of the user and reconstruct the virtual objects. In addition, the camera module 104 is rotatable on the HMD 102 to maximize a tracking range. For example, when the user wears the HMD 102 equipped with the camera module 104, the extended reality system 10 may reconstruct the 3D virtual space and the 3D virtual objects with an inside-out tracking method based on the hand gestures, the steps of the user, and the space captured by the camera module 104. Therefore, the extended reality system 10 of the present invention virtualizes the body behavior of the user and reconstructs the virtual objects in the extended reality (XR) environment without implementing extra devices to reconstruct virtual contents.

The examples mentioned above briefly explain that the extended reality system 10 of the present invention reconstructs the virtual space and the virtual objects without implementing extra devices. Notably, those skilled in the art may make proper modifications. For example, the optical modules included in the camera module 104 are not limited to those mentioned above, and one or more optical modules may be adopted to implement the reconstruction of the virtual space and the virtual objects, but not limited thereto, which belongs to the scope of the present invention.

In detail, the first optical module C1 may be a wide field-of-view (FOV) RGB camera for tracking the hand motion of the user with a simultaneous localization and mapping (SLAM), which reconstructs or updates a map of an unknown environment while simultaneously keeping track of the user's location within it. In an embodiment, when the user's hand is moving, the FOV RGB camera tracks the hand motion with a wide FOV angle and the SLAM. Notably, the FOV angle of the FOV RGB camera is at least 100 degrees. Therefore, the extended reality system 10 of the present invention integrates the first optical module C1 with the SLAM to track the user's hand motion under the circumstance of being without trackers or the outside-in devices, e.g. the motion controllers and cameras to track or sense the movements of the users.

In order to reconstruct the virtual space, the hand gestures and the steps of the user, the second optical module C2 is utilized. In an embodiment, the second optical module C2 may be implemented by a RGB-Depth (RGB-D) camera. Therefore, the control unit 106 utilizes the RGB-D camera to reconstruct the 3D space the hand gestures or the steps of the user in accordance with a depth model or a depth algorithm. More specifically, when in the virtual 3D space, which is an application of the VR and AR environment, the RGB-D camera captures pictures with hand gestures and steps of the user with depth information, so as to recognize the dynamic hand gestures and steps. Similarly, the virtual 3D space may be reconstructed based on the pictures took by the RGB-D camera. In other words, the RGB-D camera scans the space surrounding the user to build the virtual 3D space. Therefore, the second optical module C2 of the extended reality system 10 may be integrated to reconstruct the virtual space, the hand gestures and the steps of the user, without the outside-in devices to sense and track the movements of the users.

In addition, the third optical module C3 may be a high-definition (HD) camera for taking pictures of the objects, so as to reconstruct the virtual objects in the 3D space. More specifically, the HD camera takes pictures of objects surrounding the user, such that the control unit 106 may establish the virtual objects in the virtual 3D space without the outside-in devices, and alternatively, the control unit 106 may integrate the pictures took by the HD camera with an object reconstruction algorithm to establish the virtual objects. Therefore, the extended reality system 10 may reconstruct the virtual objects in accordance with the third optical module C3 without the outside-in devices or other auxiliary devices.

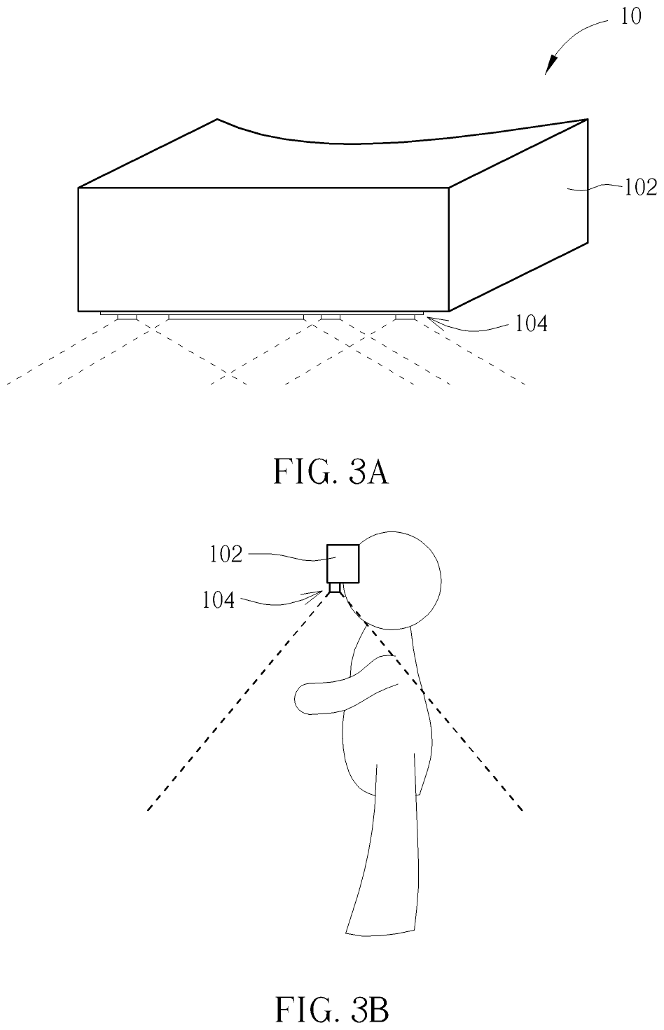

Notably, the embodiments stated above illustrate the concept of the present invention, those skilled in the art may make proper modifications accordingly, and not limited thereto. In an embodiment, please refer to FIGS. 3A and 3B, which are schematic diagrams of the extended reality system 10 when applied on the user according to an embodiment of the present invention. As shown in FIGS. 3A and 3B, dash lines represent ranges of each of the optical modules of the camera module 104, which covers the hands, foot and body of the user, such that the extended reality system 10 may reconstruct and virtualize the 3D virtual objects and space without the outside-in devices. Moreover, since the camera module 104 is rotatable when disposed on the HMD 102, the tracking range is maximized. In another embodiment, the optical modules C1, C2 and C3 of the camera module 104 are individually rotatable in different dimensions, so as to maximize the tracking range.

In summary, the present invention provides a camera module and an extended reality system with an inside-out tracking method, so as to provide a better experience when the user experiences the extended reality environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera module, for a head-mounted display (HMD), comprising:
a first optical module for tracking a hand motion of a user;
a second optical module for reconstructing a hand gesture or a step of the user and a space;
a third optical module for establishing a three-dimensional (3D) virtual object; and
a control unit for integrating with the first optical module, the second optical module and the third optical module to virtualize a body behavior of the user;
wherein the camera module is rotatable to maximize a tracking range.

2. The camera module of claim 1, wherein the first optical module is a wide field-of-view (FOV) RGB camera for tracking the hand motion of the user with a simultaneous localization and mapping (SLAM).

3. The camera module of claim 2, wherein an FOV angle of the FOV RGB camera is at least 100 degrees.

4. The camera module of claim 1, wherein the second optical module is a RGB-Depth (RGB-D) camera.

5. The camera module of claim 4, wherein the control unit reconstructs the hand gesture, the step of the user and the space by the RGB-D camera and a depth algorithm.

6. The camera module of claim 1, wherein the third optical module is a high-definition (HD) camera for taking a plurality of pictures.

7. An extended reality system, comprising:
a head-mounted display; and
a camera module disposed on the head-mounted display, and the camera module comprises:
a first optical module for tracking a hand motion of an user;
a second optical module for reconstructing a hand gesture of the user and a space;
a third optical module for establishing a three-dimensional (3D) virtual object; and
a control unit for integrating with the first optical module, the second optical module and the third optical module to virtualize a body behavior of the user;
wherein the camera module is rotatable on the HMD to maximize a tracking range.

8. The extended reality system of claim 7, wherein the first optical module is a wide field-of-view (FOV) RGB camera for tracking the hand motion of the user with a simultaneous localization and mapping (SLAM).

9. The extended reality system of claim 8, wherein an FOV angle of the FOV RGB camera is at least 100 degrees.

10. The extended reality system of claim 7, wherein the second optical module is a RGB-Depth (RGB-D) camera.

11. The extended reality system of claim 10, wherein the control unit reconstructs the hand gesture, the step of the user and the space by the RGB-D camera and a depth algorithm.

12. The extended reality system of claim 7, wherein the third optical module is a high-definition (HD) camera for taking a plurality of pictures.
